(19) United States
(12) Patent Application Publication
(10) Pub. No.: US 2021/0084291 A1
(43) Pub. Date: Mar. 18, 2021

(54) INTER CODING FOR ADAPTIVE RESOLUTION VIDEO CODING

(71) Applicant: Alibaba Group Holding Limited, Grand Cayman (KY)

(72) Inventors: Tsuishan Chang, Hangzhou (CN); Yu-Chen Sun, Bellevue, WA (US); Ling Zhu, Hangzhou (CN); Jian Lou, Bellevue, WA (US)

(21) Appl. No.: 17/048,446

(22) PCT Filed: Mar. 11, 2019
(86) PCT No.: PCT/CN2019/077665

§ 371 Date: Oct. 16, 2020

(51) Int. Cl. H04N 19/105; H04N 19/52; H04N 19/172

(52) U.S. Cl. CPC H04N 19/105; H04N 19/172; H04N 19/52

(57) ABSTRACT

Systems and methods are provided for implementing methods for resolution-adaptive video coding in a motion prediction coding format by obtaining a current frame of a bitstream, obtaining one or more reference pictures from a reference frame buffer, up-sampling or down-sampling the obtained reference pictures that have resolutions different from a resolution of the current frame, resizing an inter predictor of the one or more reference pictures, and generating a reconstructed frame from the current frame based on the one or more reference pictures and motion information of one or more blocks of the current frame, the motion information including at least one inter predictor, thereby achieving substantial reduction of network transport costs in video coding and delivery without requiring the transport of additional data that would offset or compromise these savings.

### BACKGROUND

In conventional video coding formats, such as the H.264/AVC (Advanced Video Coding) and H.265/HEVC (High Efficiency Video Coding) standards, video frames in a sequence have their size and resolution recorded at the sequence-level in a header. Thus, in order to change frame resolution, a new video sequence must be generated, starting with an intra-coded frame, which carries significantly larger bandwidth costs to transmit than inter-coded frames. Consequently, although it is desirable to adaptively transmit a down-sampled, low resolution video over a network when network bandwidth becomes low, reduced or throttled, it is difficult to realize bandwidth savings while using conventional video coding formats, because the bandwidth costs of adaptively down-sampling offset the bandwidth gains.

Research has been conducted into supporting resolution changing while transmitting inter-coded frames. In the implementation of the AV1 codec, developed by AOM, a new frame type called a switch_frame is provided, which may be transmitted having different resolution than that of previous frames. However, a switch_frame is restricted in its usage, as motion vector coding of a switch_frame cannot reference motion vectors of previous frames. Such references conventionally provide another way to reduce bandwidth costs, so the use of switch_frames still sustains greater bandwidth consumption which offsets bandwidth gains.

Furthermore, existing motion coding tools perform motion compensation prediction (MCP) based on only translation motion models.

In the development of the next-generation video codec specification, VVC/H.266, several new motion prediction coding tools are provided to further support motion vector coding which references previous frames, as well as MCP based on irregular types of motion other than translation motion. New techniques are required in order to implement resolution change in a bitstream with regard to these new coding tools.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate configurations of a plurality of CMPVs for a 4-parameter affine motion model and a 6-parameter affine motion model, respectively.

FIG. 2 illustrates a diagram of deriving motion information of a luma component of a block.

FIG. 3 illustrates an example selection of motion candidates for a CU of a frame according to affine motion prediction coding.

FIG. 4 illustrates examples of deriving inherited affine merge candidates.

FIG. 5 illustrates examples of deriving a constructed affine merge candidate

FIG. 6 illustrates a diagram of a DMVR bi-prediction process based on template matching.

FIG. 7 illustrates an example block diagram of a video coding process.

FIGS. 8A, 8B, and 8C illustrate example flowcharts of a video coding method implementing resolution-adaptive video coding.

FIGS. 9A, 9B and 9C illustrate further example flowcharts of a video coding method implementing resolution-adaptive video coding.

FIG. 10 illustrates an example system for implementing processes and methods for implementing resolution-adaptive video coding in a motion prediction coding format.

FIG. 11 illustrates an example system for implementing processes and methods for implementing resolution-adaptive video coding in a motion prediction coding format.

### DETAILED DESCRIPTION

Systems and methods discussed herein are directed to enabling adaptive resolutions in video encoding, and more specifically to implementing up-sampling and down-sampling of reconstructed frames to enable inter-frame adaptive resolution changes based on motion prediction coding tools provided for by the VVC/H.266 standard.

According to example embodiments of the present disclosure, a motion prediction coding format may refer to a data format encoding motion information and prediction units (PUs) of a frame by the inclusion of one or more references to motion information and PUs of one or more other frames. Motion information may refer to data describing motion of a block structure of a frame or a unit or subunit thereof, such as motion vectors and references to blocks of a current frame or of another frame. PUs may refer to a unit or multiple subunits corresponding to a block structure among multiple block structures of a frame, such as a coding unit (CU), wherein blocks are partitioned based on the frame data and are coded according to established video codecs. Motion information corresponding to a prediction unit may describe motion prediction as encoded by any motion vector coding tool, including, but not limited to, those described herein.

According to example embodiments of the present disclosure, motion prediction coding formats may include affine motion prediction coding and decoder-side motion vector refinement (DMVR). Features of these motion prediction coding formats relating to example embodiments of the present disclosure shall be described herein.

A decoder according to affine motion prediction coding may obtain a current frame of a bitstream encoded according to a coding format employing an affine motion model, and derive a reconstructed frame (an “affine motion prediction coding reconstructed frame”). A current frame may be inter-coded.

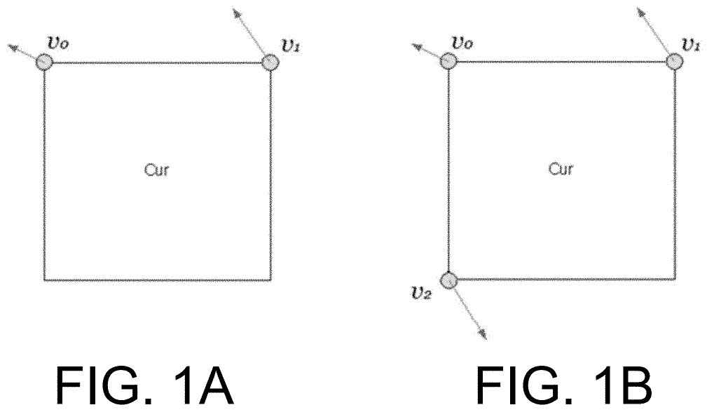

Motion information of a CU of an affine motion prediction coding reconstructed frame may be predicted by affine motion compensated prediction. The motion information may include a plurality of motion vectors, including a plurality of control point motion vectors (CPMVs) and a derived motion vector. As illustrated by FIGS. 1A and 1B, the plurality of CPMVs may include two motion vectors \vec{v₀} and \vec{v₁} of the CU serving as two control points or three motion vectors \vec{v₀}, \vec{v₁}, and \vec{v₂} of the CU serving as three control points, where \vec{v₀}=(mv₀ₓ, mv_{0y}) is a control point at an upper left corner of the CU, \vec{v₁}=(mv₁ₓ, mv_{1y}) is a control point at an upper right corner of the CU, and \vec{v₂}=(mv₂ₓ, mv_{2y}) is a control point at a lower left corner of the CU. The derived motion vector may be derived by an affine motion model from the control points and from a sample location (x, y) pixel of the CU, which may be a 4-parameter affine motion model for two control points, or a 6-parameter affine motion model for three control points.

A motion vector at sample location (x, y) may be derived from two control points by the operation:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 y} - m {v}_{0 x}}{W} y + m {v}_{0 y}\end{matrix}$$

A motion vector at sample location (x, y) may be derived from three control points by the operation:

$$\{ \begin{matrix}m {v}_{x} = \frac{m {v}_{1 x} - m {v}_{0 x}}{W} x + \frac{m {v}_{2 x} - m {v}_{0 x}}{W} y + m {v}_{0 x} \\ m {v}_{y} = \frac{m {v}_{1 y} - m {v}_{0 y}}{W} x + \frac{m {v}_{2 y} - m {v}_{0 y}}{W} y + m {v}_{0 y}\end{matrix}$$

The motion information may further be predicted by deriving motion information of a luma component of the block, and deriving motion information of a chroma component of the block by applying block-based affine transform upon motion information of the block.

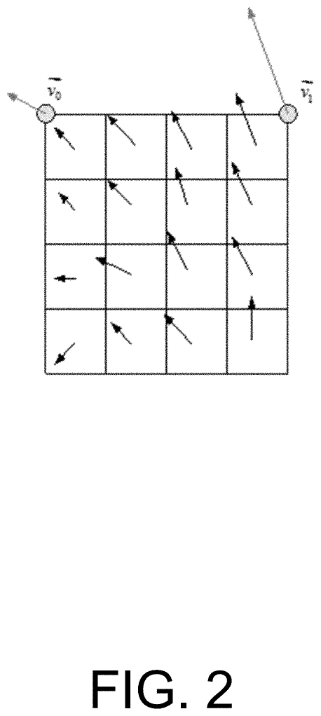

As illustrated by FIG. 2, a luma component of the block may be divided into luma sub-blocks of 4×4 pixels, wherein for each luma sub-block, a luma motion vector at a sample location at a center of the luma sub-block may be derived in accordance with the above-mentioned operations from control points of the overall CU. Derived luma motion vectors of luma sub-blocks may be rounded to accuracy of 1/16.

A chroma component of the block may be divided into chroma sub-blocks of 4×4 pixels, wherein each chroma sub-block may have four neighboring luma sub-blocks. For example, a neighboring luma sub-block may be a luma sub-block below, left of, right of, or above the chroma sub-block. For each chroma sub-block, a motion vector may be derived from an average of luma motion vectors of the neighboring luma sub-blocks.

A motion compensation interpolation filter may be applied to a derived motion vector of each sub-block to generation a motion prediction of each sub-block.

Motion information of a CU of an affine motion prediction coding reconstructed frame may include a motion candidate list. A motion candidate list may be a data structure containing references to multiple motion candidates. A motion candidate may be a block structure or a subunit thereof, such as a pixel or any other suitable subdivision of a block structure of a current frame, or may be a reference to a motion candidate of another frame. A motion candidate may be a spatial motion candidate or a temporal motion candidate. By applying motion vector compensation (MVC), a decoder may select a motion candidate from the motion candidate list and derive a motion vector of the motion candidate as a motion vector of the CU of the reconstructed frame.

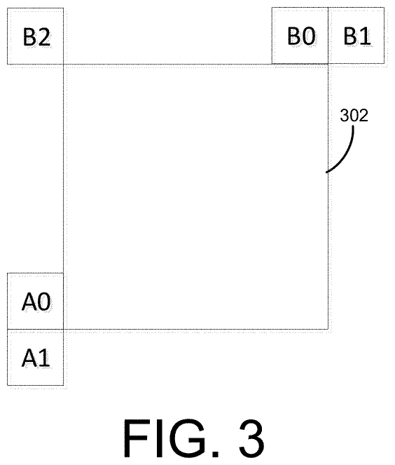

FIG. 3 illustrates an example selection of motion candidates for a CU of a frame according to affine motion prediction coding according to an example embodiment of the present disclosure.

According to example embodiments of the present disclosure wherein the affine motion prediction mode of an affine motion prediction coding reconstructed frame is an affine merge mode, CUs of the frame have both width and height greater than or equal to 8 pixels. The motion candidate list may be an affine merge candidate list and may include up to five CPMVP candidates. The coding of the CU may include a merge index. A merge index may refer to a CPMVP candidate of an affine merge

CPMVs of the current CU may be generated based on control point motion vector predictor (CPMVP) candidates derived from motion information of spatially neighboring blocks or temporally neighboring blocks to the current CU.

As shown by FIG. 3, multiple spatially neighboring blocks of a current CU of a frame are present. Spatially neighboring blocks of the current CU may be blocks neighboring a left side of the current CU and blocks neighboring a top of the current CU. Spatially neighboring blocks have left-right relationships and above-below relationships corresponding to left-right and above-below orientations of FIG. 3. By the example of FIG. 3, an affine merge candidate list for a frame coded according to an affine motion prediction mode which is an affine merge mode may include up to the following CPMVP candidates:

A left spatially neighboring block (A₀);

An upper spatially neighboring block (B₀);

An upper-right spatially neighboring block (B₁);

A lower-left spatially neighboring block (A₁); and

An upper-left spatially neighboring block (B₂).

Of the spatially neighboring blocks shown herein, block A₀ may be a block left of the current CU 302; block A₁ may be a block left of the current CU 302; block B₀ may be a block above the current CU 302; block B₁ may be a block above the current CU 302; and block B₂ may be a block above the current CU 302. The relative positioning of each spatially neighboring block to the current CU 302, or relative to each other, shall not be further limited. There shall be no limitation as to relative sizes of each spatially neighboring block to the current CU 302 or to each other.

An affine merge candidate list for a CU of a frame coded according to an affine motion prediction mode which is an affine merge mode may include the following CPMVP candidates:

Up to two inherited affine merge candidates;

A constructed affine merge candidate; and

A zero motion vector.

An inherited affine merge candidate may be derived from a spatially neighboring block having affine motion information, that is, a spatially neighboring block belonging to a CU having CPMVs.

A constructed affine merge candidate may be derived from spatially neighboring blocks and temporally neighboring blocks not having affine motion information, that is, CPMVs may be derived from spatially neighboring blocks and temporally neighboring blocks belonging to CUs having only translational motion information.

A zero motion vector may have a motion shift of (0, 0).

At most one inherited affine merge candidate may be derived from searching spatially neighboring blocks left of the current CU, and at most one inherited affine merge candidate may be derived from searching spatially neighboring blocks above the current CU. The left spatially neighboring blocks may be searched in the order of A₀ and A₁, and the above spatially neighboring blocks may be searched in the order of B₀, B₁, and B₂, in each case for a first spatially neighboring block having affine motion information. In the case that such a first spatially neighboring block is found among the left spatially neighboring blocks, a CPMVP candidate is derived from the CPMVs of the first spatially neighboring block and added to the affine merge candidate list. In the case that such a first spatially neighboring block is found among the above spatially neighboring blocks, a CPMVP candidate is derived from the CPMVs of the first spatially neighboring block and added to the affine merge candidate list. In the case that two CPMVP candidates are derived in this manner, no pruning check among the derived CPMVP candidates is performed, that is, the two derived CPMVP candidates are not checked as to whether they are the same CPMVP candidate.

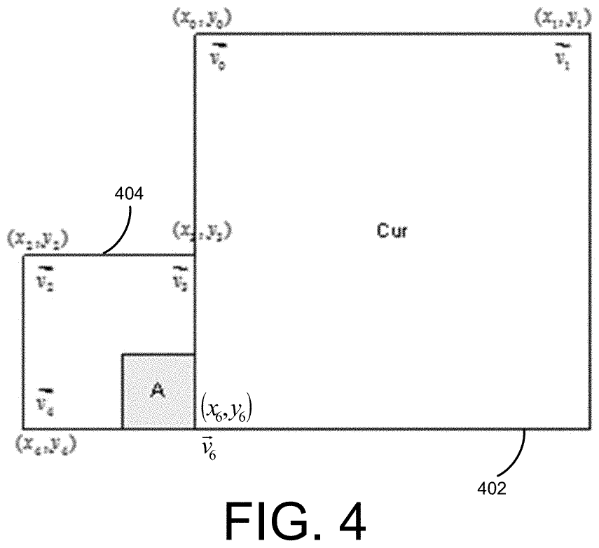

FIG. 4 illustrates examples of deriving inherited affine merge candidates. A current CU 402 has a left spatially neighboring block A. The block A belongs to a CU 404. When block A is coded according to a 4-parameter affine model, CU 404 may have the following affine motion information: \vec{v₂}=(x₂, y₂) is a CPMV at an upper left corner of the CU 404, and \vec{v₃}=(x₃, y₃) is a CPMV at an upper right corner of the CU 404. Upon finding block A, the CPMVs \vec{v₂} and \vec{v₃} may be obtained, and CPMVs \vec{v₀} and \vec{v₁} of the current CU 402 for a sample location may be calculated in accordance with the CPMVs \vec{v₂} and \vec{v₃}, resulting in a 4-parameter affine merge candidate.

When block A is coded according to a 6-parameter affine model, CU 404 may, additionally, have the following affine motion information: \vec{v₄}=(x₄, y₄) is a CPMV at a lower left corner of the CU. Upon finding block A, the CPMVs \vec{v₂}, \vec{v₃}, and \vec{v₄} may be obtained, and CPMVs \vec{v₀}, \vec{v₁}, and \vec{v₆} of the current CU 402 for a sample location may be calculated in accordance with the CPMVs \vec{v₂}, \vec{v₃}, and \vec{v₄}, resulting in a 6-parameter affine merge candidate.

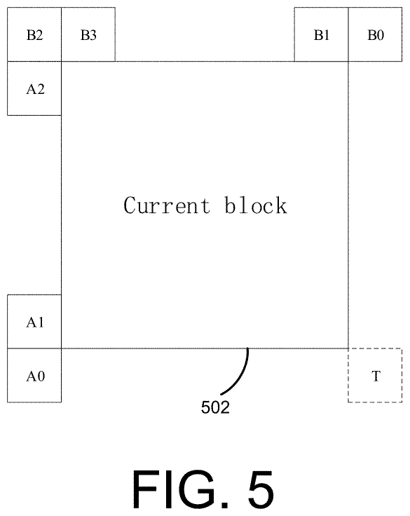

FIG. 5 illustrates examples of deriving a constructed affine merge candidate. A constructed affine merge candidate may be derived from four CPMVs of the current CU 502, where each CPMV of the current CU 502 is derived from searching spatially neighboring blocks of the current CU 502 or from a temporally neighboring block of the current CU 502.

The following blocks may be referenced in deriving CPMVs:

A left spatially neighboring block (A₁);

A left spatially neighboring block (A₂);

An upper spatially neighboring block (B₁);

An upper-right spatially neighboring block (B₀);

A lower-left spatially neighboring block (A₀);

An upper-left spatially neighboring block (B₂);

An upper spatially neighboring block (B₃); and

A temporally neighboring block (T).

The following CPMVs may be derived for the current CU 502:

An upper left CPMV (CPMV₁);

An upper right CPMV (CPMV₂);

A lower left CPMV (CPMV₃); and

A lower right CPMV (CPMV₄).

CPMV₁ may be derived by searching the spatially neighboring blocks B₂, B₃, and A₂ in this order and selecting the first available spatially neighboring block in accordance with criteria found in relevant technology, details of which shall not be elaborated herein.

CPMV₂ may be derived by searching the spatially neighboring blocks B₁ and B₀ in this order and likewise selecting the first available spatially neighboring block.

CPMV₃ may be derived by searching the spatially neighboring blocks A₁ and A₀ in this order and likewise selecting the first available spatially neighboring block.

CPMV₄ may be derived from the temporally neighboring block T if it is available.

A constructed affine merge candidate may be constructed using the first available combination, in the order given, of CPMVs of the current CU 502 among the following combinations:

{CPMV₁, CPMV₂, CPMV₃};

{CPMV₁, CPMV₂, CPMV₄};

{CPMV₁, CPMV₃, CPMV₄};

{CPMV₂, CPMV₃, CPMV₄};

{CPMV₁, CPMV₂}; and

{CPMV₁, CPMV₃}.

In the cases that a combination of three CPMVs is used, a 6-parameter affine merge candidate is generated. In the cases that a combination of two CPMVs is used, a 4-parameter affine merge candidate is generated. The constructed affine merge candidate is then added to the affine merge candidate list.

For a block not having affine motion information, such as a block belonging to a CU coded according to a Temporal Motion Vector Predictor (TMVP) coding format, the coding of the CU may include an inter prediction indicator. An inter prediction indicator may indicate list 0 prediction in reference to a first reference picture list referred to as list 0, list 1 prediction in reference to a second reference picture list referred to as list 1, or bi-prediction in reference to two reference picture lists referred to as, respectively, list 0 and list 1. In the cases of the inter prediction indicator indicating list 0 prediction or list 1 prediction, the coding of the CU may include a reference index referring to a reference picture of the reference frame buffer referenced by list 0 or by list 1, respectively. In the case of the inter prediction indicator indicating bi-prediction, the coding of the CU may include a first reference index referring to a first reference picture of the reference frame buffer referenced by list 0, and a second reference index referring to a second reference picture of the reference frame referenced by list 1.

The inter prediction indicator may be coded as a flag in a slice header of an inter-coded frame. The reference index or indices may be coded in a slice header of an inter-coded frame. One or two motion vector differences (MVDs) respectively corresponding to the reference index or indices may further be coded.

In the case that, in a particular combination of CPMVs as described above, reference indices of CPMVs are different, that is, CPMVs may be derived from CUs referencing different reference pictures which may have different resolutions, the particular combination of CPMVs may be discarded and not used.

After adding any derived inherited affine merge candidates and any constructed affine merge candidates to the affine merge candidate list for the CU, zero motion vectors, that is, motion vectors indicating a motion shift of (0, 0), are added to any remaining empty positions of the affine merge candidate list.

According to example embodiments of the present disclosure wherein the affine motion prediction mode of an affine motion prediction coding reconstructed frame is an affine adaptive motion vector prediction (AMVP) mode, CUs of the frame have both width and height greater than or equal to 16 pixels. The applicability of AMVP mode, and whether a 4-parameter affine motion model or a 6-parameter affine motion model is used, may be signaled by bit-level flags carried in a video bitstream carrying the coded frame data. The motion candidate list may be an AMVP candidate list and may include up to two AMVP candidates.

CPMVs of the current CU may be generated based on AMVP candidates derived from motion information of spatially neighboring blocks to the current CU.

An AMVP candidate list for a CU of a frame coded according to an affine motion prediction mode which is an AMVP mode may include the following CPMVP candidates:

An inherited AMVP candidate;

A constructed AMVP candidate;

A translational motion vector from a neighboring CU; and

A zero motion vector.

An inherited AMVP candidate may be derived in the same fashion as that for deriving an inherited affine merge candidate, except that each spatially neighboring block searched for deriving the inherited AMVP candidate belongs to a CU referencing a same reference picture as the current CU. No pruning check is performed between an inherited AMVP candidate and the AMVP candidate list while adding the inherited AMVP candidate to the AMVP candidate list.

A constructed AMVP candidate may be derived in the same fashion as that for deriving a constructed affine merge candidate, except that selecting the first available spatially neighboring block is further performed in accordance with the criteria that the first available spatially neighboring block that is inter-coded and having a reference index referencing a same reference picture as the current CU is selected. Moreover, in accordance with implementations of AMVP wherein temporal control points are not supported, temporally neighboring blocks may not be searched.

In the case that the current CU is coded by a 4-parameter affine motion model, and CPMV₁ and CPMV₂ of the current CU are available, CPMV₁ and CPMV₂ are added to the AMVP candidate list as one candidate. In the case that the current CU is coded by a 6-parameter affine motion model, and CPMV₁, CPMV₂, and CPMV₃ of the current CU are available, CPMV₁, CPMV₂, and CPMV₃ are added to the AMVP candidate list as one candidate. Otherwise, a constructed AMVP candidate is not available to be added to the AMVP candidate list.

A translational motion vector may be a motion vector from a spatially neighboring block belonging to a CU having only translational motion information.

A zero motion vector may have a motion shift of (0, 0).

After adding any derived inherited affine merge candidates and any constructed affine merge candidates to the affine merge candidate list for the CU, CPMV₁, CPMV₂, and CPMV₃, in accordance with respective availability, are added to the AMVP candidate list in the given order as translational motion vectors to predict all CPMVs of the current CU. Then, zero motion vectors, that is, motion vectors indicating a motion shift of (0, 0), are added to any remaining empty positions of the AMVP candidate list.

Motion information predicted in accordance with DMVR may be predicted by bi-prediction. Bi-prediction may be performed upon a current frame such that motion information of a block of a reconstructed frame may include a reference to a first motion vector of a first reference block and a second motion vector of a second reference block, the first reference block having a first temporal distance from the current block and the second reference block having a second temporal distance from the current block. The first temporal distance and the second temporal distance may be in different temporal directions from the current block.

The first motion vector may be a motion vector of a block of a first reference picture of a first reference picture list referred to as list 0, and the second motion vector may be a motion vector of a block of a second reference picture of a second reference picture list referred to as list 1. The coding of the CU to which the current block belongs may include a first reference index referring to a first reference picture of the reference frame referenced by list 0, and a second reference index referring to a second reference picture of the reference frame referenced by list 1.

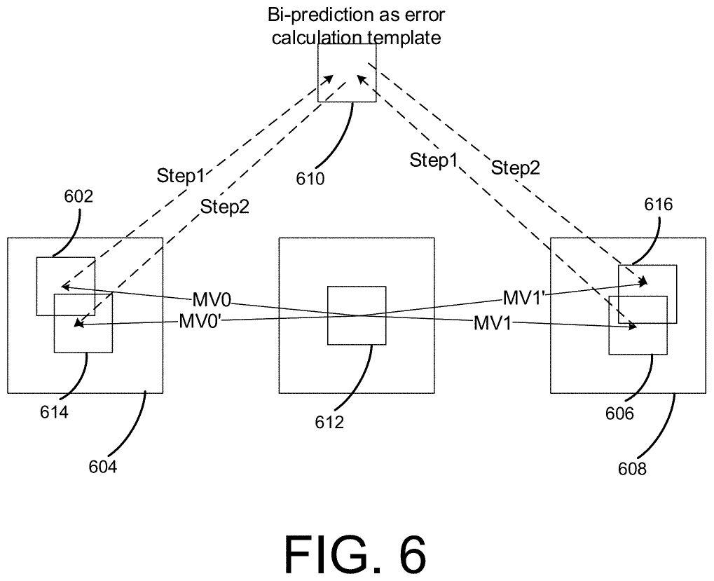

FIG. 6 illustrates a diagram of a DMVR bi-prediction process based on template matching. In a first step of the DMVR bi-prediction process, an initial first block 602 of a first reference picture 604 of list 0 referenced by an initial first motion vector mv₀ and an initial second block 606 of a second reference picture 608 of list 1 referenced by an initial second motion vector mv₁ are averaged to generate a weighted combination of the initial first block 602 and the initial second block 606. The weighted combination serves as a template 610. Motion prediction for the current block 612 may be performed using an initial first motion vector which references the initial first block 602 and an initial second motion vector which references the initial second block 606.

In a second step of the DMVR bi-prediction process, the template 610 is compared to a first sample region of the first reference picture 604 proximate to the initial first block 602 and a second sample region of the second reference picture 608 proximate to the initial second block 606 by a cost measurement. The cost measurement may utilize suitable measures of image similarity such as a sum of absolute differences or a mean removed sum of absolute differences. Within the first sample region, if a subsequent first block 614 has a minimum cost measured against the template, a subsequent first motion vector mv₀′ referencing the subsequent first block 614 may replace the initial first motion vector mv₀. Within the second sample region, if a subsequent second block 616 has a minimum cost measured against the template, a subsequent second motion vector mv₁′ referencing the subsequent second block 616 may replace the initial second motion vector mv₁. Bi-prediction may then be performed for the current block 612 using mv₀′ and mv₁′.

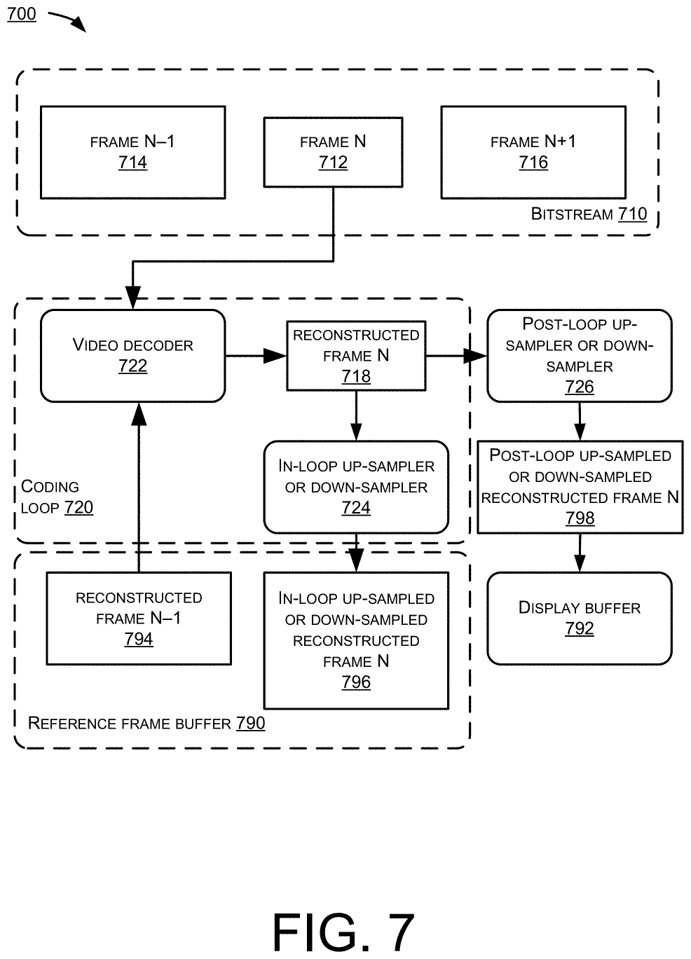

FIG. 7 illustrates an example block diagram of a video coding process 700 according to an example embodiment of the present disclosure.

The video coding process 700 may obtain a coded frame from a source such as a bitstream 710. According to example embodiments of the present disclosure, given a current frame 712 having position N in the bitstream, a previous frame 714 having position N−1 in the bitstream may have a resolution larger than or smaller than a resolution of current frame, and a next frame 716 having position N+1 in the bitstream may have a resolution larger than or smaller than the resolution of the current frame.

The video coding process 700 may decode the current frame 712 to generate a reconstructed frame 718, and output the reconstructed frame 718 at a destination such as a reference frame buffer 790 or a display buffer 792. The current frame 712 may be input into a coding loop 720, which may include repeating the steps of inputting the current frame 712 into a video decoder 722, generating a reconstructed frame 718 based on a previous reconstructed frame 794 of the reference frame buffer 790, inputting the reconstructed frame 718 into an in-loop up-sampler or down-sampler 724, generating an up-sampled or down-sampled reconstructed frame 796, and outputting the up-sampled or down-sampled reconstructed frame 796 into the reference frame buffer 790. Alternatively, the reconstructed frame 718 may be output from the loop, which may include inputting the reconstructed frame into a post-loop up-sampler or down-sampler 726, generating an up-sampled or down-sampled reconstructed frame 798, and outputting the up-sampled or down-sampled reconstructed frame 798 into the display buffer 792.

According to example embodiments of the present disclosure, the video decoder 722 may be any decoder implementing a motion prediction coding format, including, but not limited to, those coding formats described herein. Generating a reconstructed frame based on a previous reconstructed frame of the reference frame buffer 790 may include inter-coded motion prediction as described herein, wherein the previous reconstructed frame may be an up-sampled or down-sampled reconstructed frame output by the in-loop up-sampler or down-sampler 722 during a previous coding loop, and the previous reconstructed frame serves as a reference picture in inter-coded motion prediction as described herein.

According to example embodiments of the present disclosure, an in-loop up-sampler or down-sampler 724 and a post-loop up-sampler or down-sampler 726 may each implement an up-sampling or down-sampling algorithm suitable for respectively at least up-sampling or down-sampling coded pixel information of a frame coded in a motion prediction coding format. An in-loop up-sampler or down-sampler 724 and a post-loop up-sampler or down-sampler 726 may each implement an up-sampling or down-sampling algorithm further suitable for respectively upscaling and downscaling motion information such as motion vectors.

An in-loop up-sampler or down-sampler 724 may utilize an up-sampling or down-sampling algorithm comparatively simpler and having greater computational speed compared to an algorithm utilized by a post-loop up-sampler or down-sampler 426, sufficient such that the up-sampled or down-sampled reconstructed frame 796 output by the in-loop up-sampler or down-sampler 724 may be inputted into the reference frame buffer 790 before the up-sampled or down-sampled reconstructed frame 796 is needed to serve as a previous reconstructed frame in a future iteration of the coding loop 720, whereas the up-sampled or down-sampled reconstructed frame 798 output by the post-loop up-sampler or down-sampler 726 may not be output in time before the up-sampled or down-sampled reconstructed frame 796 is thus needed. For example, an in-loop up-sampler may utilize an interpolation, average, or bilinear up-sampling algorithm not relying upon training, whereas a post-loop up-sampler may utilize a trained up-sampling algorithm.

A frame serving as a reference picture in generating a reconstructed frame 718 for the current frame 712, such as the previous reconstructed frame 794, may therefore be up-sampled or down-sampled in accordance with the resolution of the current frame 712 relative to the resolutions of the previous frame 714 and of the next frame 716. For example, the frame serving as the reference picture may be up-sampled in the case that the current frame 712 has a resolution larger than the resolutions of either or both the previous frame 714 and the next frame 716. The frame serving as the reference picture may be down-sampled in the case that the current frame 712 has a resolution smaller than either or both the previous frame 714 and the next frame 716.

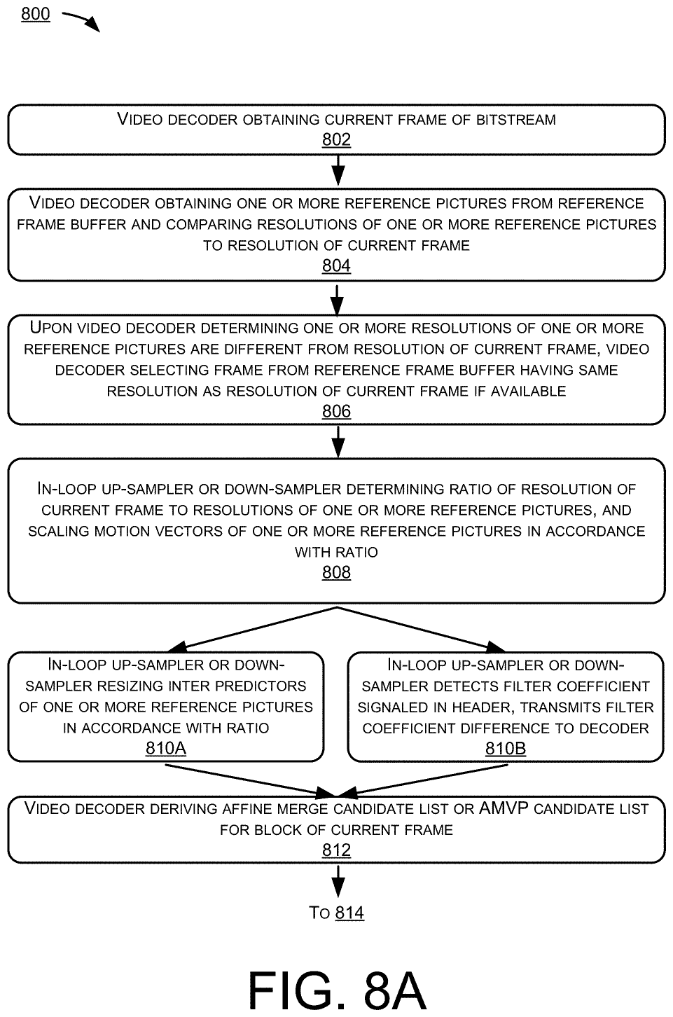

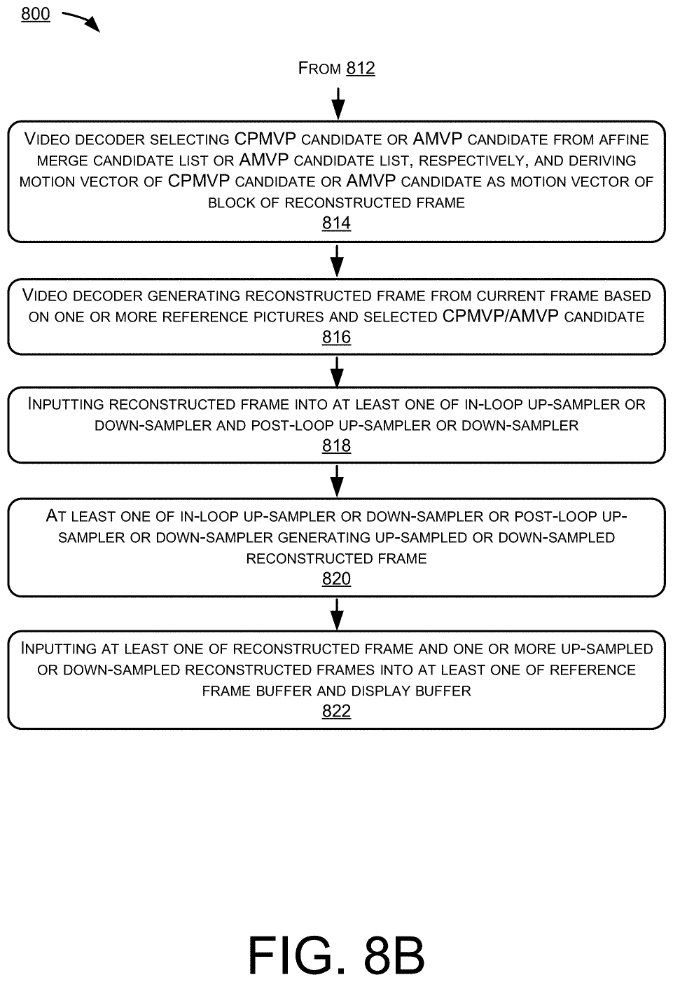

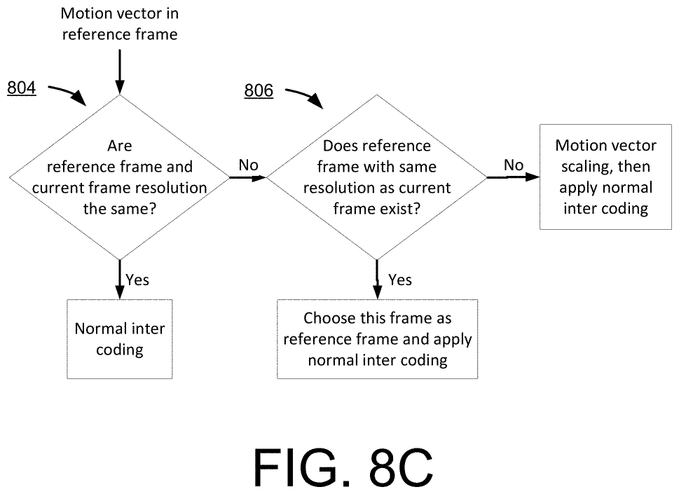

FIGS. 8A, 8B, and 8C illustrate example flowcharts of a video coding method 800 implementing resolution-adaptive video coding according to example embodiments of the present disclosure wherein frames are coded by affine motion prediction coding.

At step 802, a video decoder may obtain a current frame of a bitstream encoded by affine motion prediction coding, wherein an affine merge mode or AMVP mode may further be enabled according to bitstream signals. The current frame may have a position N. A previous frame having position N−1 in the bitstream may have a resolution larger than or smaller than a resolution of the current frame, and a next frame having position N+1 in the bitstream may have a resolution larger than or smaller than the resolution of the current frame.

At step 804, the video decoder may obtain one or more reference pictures from a reference frame buffer and compare resolutions of the one or more reference pictures to a resolution of the current frame.

At step 806, upon the video decoder determining that one or more resolutions of the one or more reference pictures are different from the resolution of the current frame, the video decoder may select a frame from the reference frame buffer having a same resolution as the resolution of the current frame, if available.

According to example embodiments of the present disclosure, the frame having a same resolution as the resolution of the current frame may be a most recent frame of the reference frame buffer having a same resolution as the resolution of the current frame, which may not be the most recent frame of the reference frame buffer.

At step 808, an in-loop up-sampler or down-sampler may determine a ratio of the resolution of the current frame to the resolutions of the one or more reference pictures; and scale motion vectors of the one or more reference pictures in accordance with the ratio.

According to example embodiments of the present disclosure, scaling motion vectors may include increasing or decreasing magnitude of the motion vectors.

At step 810A, the in-loop up-sampler or down-sampler may further resize inter predictors of the one or more reference pictures in accordance with the ratio.

According to example embodiments of the present disclosure, inter predictors may be, for example, motion information for motion prediction referencing other reference pictures which may have different resolutions.

At step 810B, alternatively, the in-loop up-sampler or down-sampler may detect an up-sample or down-sample filter coefficient signaled in a sequence header or picture header of the current frame, and transmit a difference between the signaled filter coefficient and a filter coefficient of the current frame to the video decoder. The filter coefficient may be considered to be a coefficient of the inter predictor. Thus, the difference between the filter coefficient of the inter predictor and the filter coefficient of the current frame enables predicted motion information to be applied to the filter of the current frame.

At step 812, the video decoder may derive an affine merge candidate list or an AMVP candidate list for a block of the current frame. The derivation of an affine merge candidate list or an AMVP candidate list may be performed in accordance with aforementioned steps described herein. The derivation of CPMVP candidates or AMVP candidates in the derivation of an affine merge candidate list or an AMVP candidate list, respectively, may further be performed in accordance with aforementioned steps described herein.

At step 814, the video decoder may select a CPMVP candidate or AMVP candidate from the affine merge candidate list or the AMVP candidate list and derive a motion vector of the CPMVP candidate or AMVP candidate as a motion vector of the block of the reconstructed frame, in accordance with aforementioned steps described herein.

At step 816, the video decoder may generate a reconstructed frame from the current frame based on the one or more reference pictures and the selected CPMVP or AMVP candidate.

The reconstructed frame may be predicted by reference to a selected reference picture having the same resolution as the current frame, by motion vectors or inter predictors of other frames of the reference frame buffer being respectively scaled or resized in accordance with a same resolution as the current frame, or by applying the difference between a signaled filter coefficient and a filter coefficient of the current frame transmitted from the in-loop up-sampler or down-sampler to a filter of the current frame while encoding the filter.

At step 818, the reconstructed frame may be input into at least one of the in-loop up-sampler or down-sampler and a post-loop up-sampler or down-sampler.

At step 820, the at least one of the in-loop up-sampler or down-sampler or the post-loop up-sampler or down-sampler may generate an up-sampled or down-sampled reconstructed frame based on the reconstructed frame.

A plurality of up-sampled or down-sampled reconstructed frames may be generated each in accordance with a different resolution of a plurality of resolutions supported by the bitstream.

At step 822, at least one of the reconstructed frame and the one or more up-sampled or down-sampled reconstructed frames may be input into at least one of the reference frame buffer and a display buffer.

In the case where the reconstructed frame is input into the reference frame buffer, the reconstructed frame may be obtained as a reference picture and subsequently up-sampled or down-sampled as described with regard to step 806 above in a subsequent iteration of a coding loop. In the case where the one or more up-sampled or down-sampled reconstructed frames is input into the reference frame buffer, one of one or more up-sampled or down-sampled frames may be selected as a frame having the same resolution as a current frame in a subsequent iteration of a coding loop.

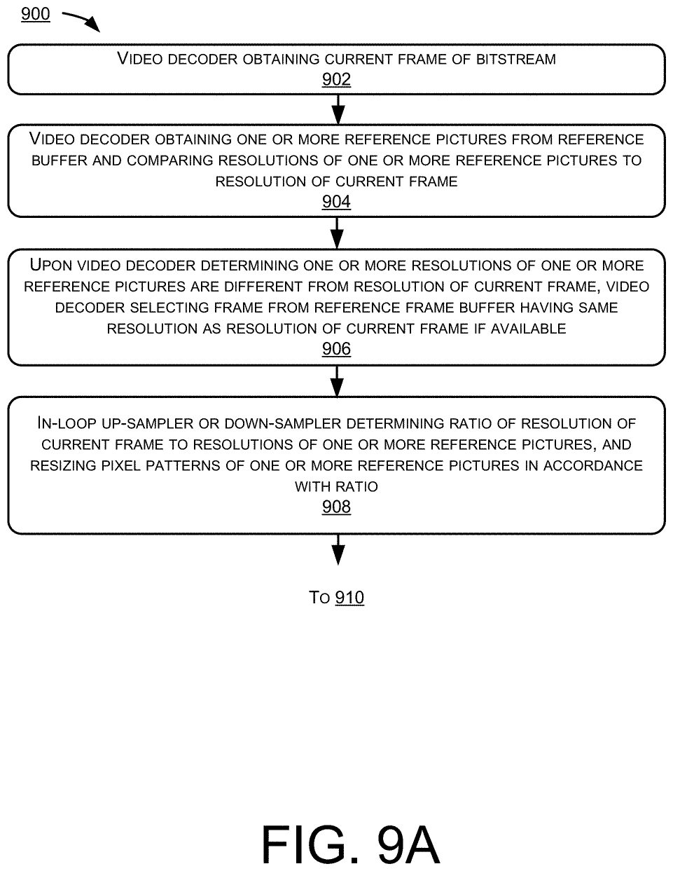

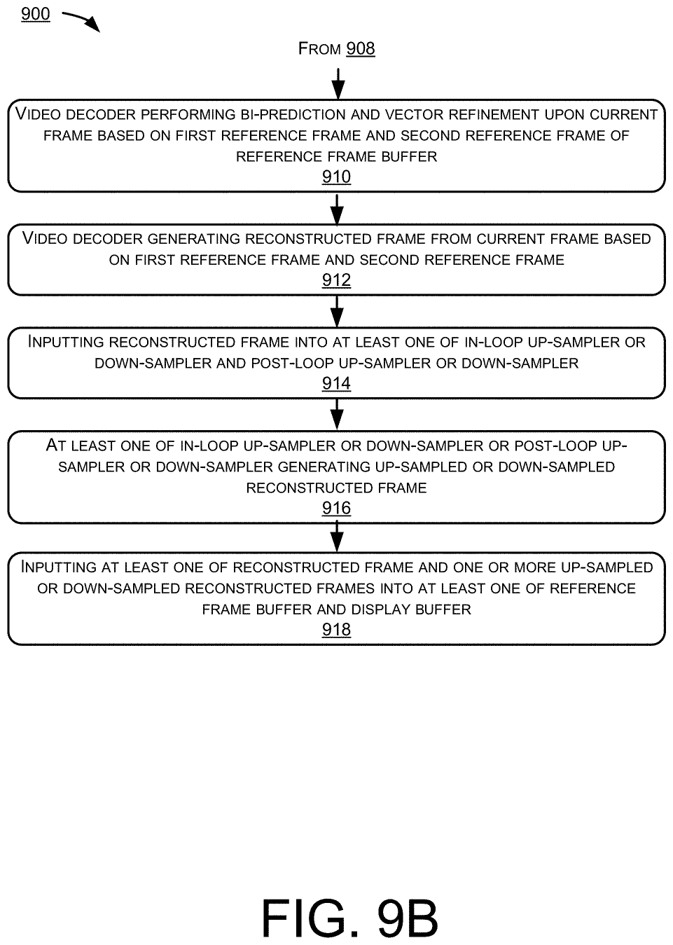

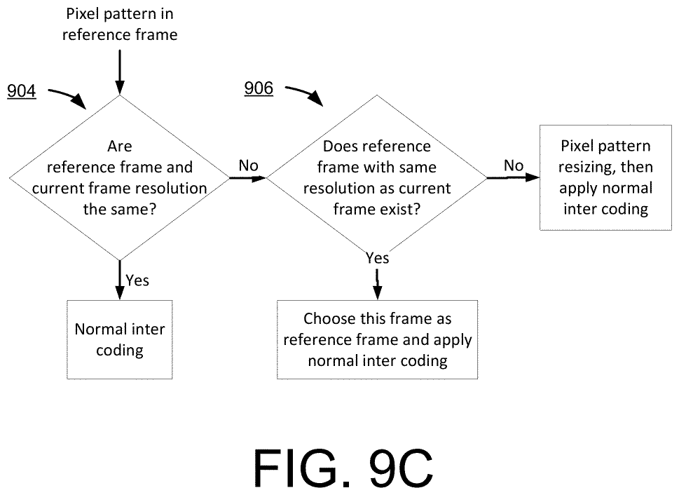

FIGS. 9A, 9B, and 9C illustrate example flowcharts of a video coding method 900 implementing resolution-adaptive video coding according to example embodiments of the present disclosure wherein motion information is predicted by DMVR.

At step 902, a video decoder may obtain a current frame of a bitstream. The current frame may have a position N. A previous frame having position N−1 in the bitstream may have a resolution larger than or smaller than a resolution of current frame, and a next frame having position N+1 in the bitstream may have a resolution larger than or smaller than the resolution of the current frame.

At step 904, the video decoder may obtain one or more reference pictures from a reference frame buffer and compare resolutions of the one or more reference pictures to a resolution of the current frame.

At step 906, upon the video decoder determining that one or more resolutions of the one or more reference pictures are different from the resolution of the current frame, an in-loop up-sampler or down-sampler may select a frame from the reference frame buffer having a same resolution as the resolution of the current frame, if available.

According to example embodiments of the present disclosure, the video decoder may select a frame from the reference frame buffer having a same resolution as the resolution of the current frame. The frame having a same resolution as the resolution of the current frame may be a most recent frame of the reference frame buffer having a same resolution as the resolution of the current frame, which may not be the most recent frame of the reference frame buffer.

At step 908, an in-loop up-sampler or down-sampler may determine a ratio of the resolution of the current frame to the resolutions of the one or more reference pictures; and resize pixel patterns of the one or more reference pictures in accordance with the ratio.

According to example embodiments of the present disclosure, resizing pixel patterns of the one or more reference pictures may facilitate vector refinement processes at different resolutions according to DMVR, such as, for example, the above-mentioned step of comparing a template to a first sample region of a first reference picture proximate to an initial first block and a second sample region of a second reference picture proximate to an initial second block by a cost measurement.

At step 910, the video decoder may perform bi-prediction and vector refinement upon the current frame based on a first reference frame and a second reference frame of the reference frame buffer, in accordance with aforementioned steps described herein.

At step 912, the video decoder may generate a reconstructed frame from the current frame based on the first reference frame and the second reference frame.

The reconstructed frame may be predicted by reference to a selected reference picture having the same resolution as the current frame or by pixel patterns of other frames of the reference frame buffer being resized in accordance with a same resolution as the current frame.

At step 914, the reconstructed frame may be input into at least one of the in-loop up-sampler or down-sampler and a post-loop up-sampler or down-sampler.

At step 916, the at least one of the in-loop up-sampler or down-sampler or the post-loop up-sampler or down-sampler may generate an up-sampled or down-sampled reconstructed frame based on the reconstructed frame.

A plurality of up-sampled or down-sampled reconstructed frames may be generated each in accordance with a different resolution of a plurality of resolutions supported by the bitstream.

At step 918, at least one of the reconstructed frame and the one or more up-sampled or down-sampled reconstructed frames may be input into at least one of the reference frame buffer and a display buffer.

In the case where the reconstructed frame is input into the reference frame buffer, the reconstructed frame may be obtained as a reference picture and subsequently up-sampled or down-sampled as described with regard to step 906 above in a subsequent iteration of a coding loop. In the case where the one or more up-sampled or down-sampled reconstructed frames is input into the reference frame buffer, one of one or more up-sampled or down-sampled frames may be selected as a frame having the same resolution as a current frame in a subsequent iteration of a coding loop.

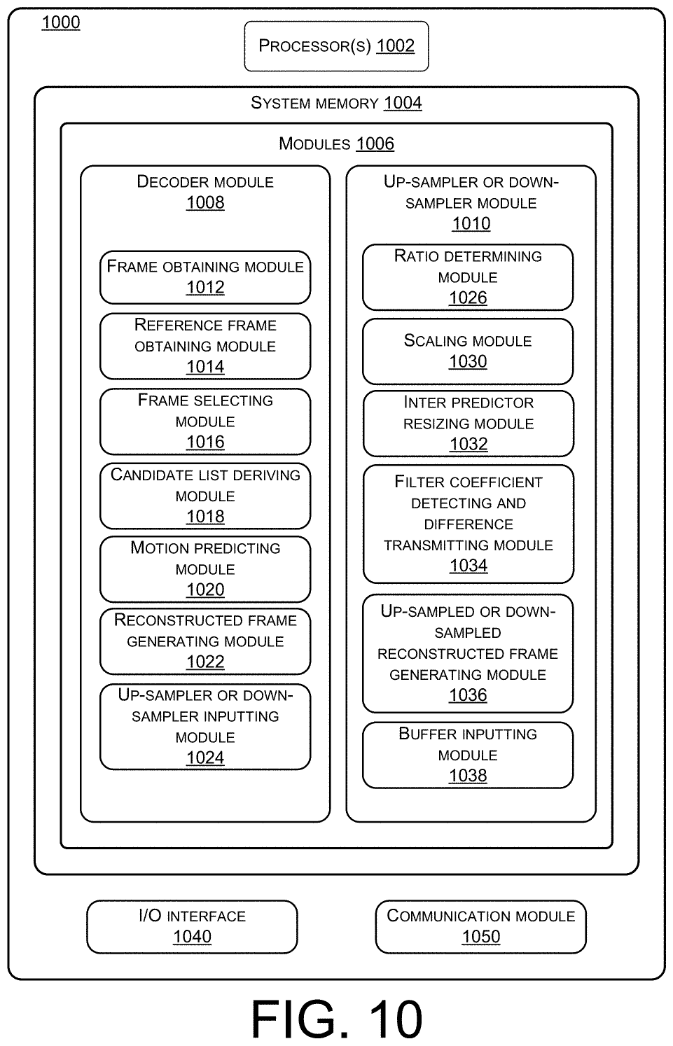

FIG. 10 illustrates an example system 1000 for implementing the processes and methods described above for implementing resolution-adaptive video coding in a motion prediction coding format.

The techniques and mechanisms described herein may be implemented by multiple instances of the system 1000 as well as by any other computing device, system, and/or environment. The system 1000 shown in FIG. 10 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1000 may include one or more processors 1002 and system memory 1004 communicatively coupled to the processor(s) 1002. The processor(s) 1002 may execute one or more modules and/or processes to cause the processor(s) 1002 to perform a variety of functions. In some embodiments, the processor(s) 1002 may include a central processing unit (CPU), a graphics processing unit (GPU), both CPU and GPU, or other processing units or components known in the art. Additionally, each of the processor(s) 1002 may possess its own local memory, which also may store program modules, program data, and/or one or more operating systems.

Depending on the exact configuration and type of the system 1000, the system memory 1004 may be volatile, such as RAM, non-volatile, such as ROM, flash memory, miniature hard drive, memory card, and the like, or some combination thereof. The system memory 1004 may include one or more computer-executable modules 1006 that are executable by the processor(s) 1002.

The modules 1006 may include, but are not limited to, a decoder module 1008 and an up-sampler or down-sampler module 1010. The decoder module 1008 may include a frame obtaining module 1012, a reference picture obtaining module 1014, a frame selecting module 1016, a candidate list deriving module 1018, a motion predicting module 1020, a reconstructed frame generating module 1022, and an up-sampler or down-sampler inputting module 1024. The up-sampler or down-sampler module 1010 may include a ratio determining module 1026, a scaling module 1030, an inter predictor resizing module 1032, a filter coefficient detecting and difference transmitting module 1034, an up-sampled or down-sampled reconstructed frame generating module 1036, and a buffer inputting module 1038.

The frame obtaining module 1012 may be configured to obtain a current frame of a bitstream encoded in an affine motion prediction coding format as abovementioned with reference to FIG. 8.

The reference picture obtaining module 1014 may be configured to obtain one or more reference pictures from a reference frame buffer and compare resolutions of the one or more reference pictures to a resolution of a current frame as abovementioned with reference to FIG. 8.

The frame selecting module 1016 may be configured to select a frame from the reference frame buffer having a same resolution as the resolution of the current frame, upon the reference picture obtaining module 1014 determining that one or more resolutions of the one or more reference pictures are different from the resolution of the current frame, as abovementioned with reference to FIG. 8.

The candidate list deriving module 1018 may be configured to derive an affine merge candidate list or an AMVP candidate list for a block of the current frame, as abovementioned with reference to FIG. 8.

The motion predicting module 1020 may be configured to select a CPMVP or AMVP candidate from the derived affine merge candidate list or AMVP candidate list and derive a motion vector of the CPMVP or AMVP candidate as a motion vector of the block of the reconstructed frame, as abovementioned with reference to FIG. 8.

The reconstructed frame generating module 1022 may be configured to generate a reconstructed frame from the current frame based on the one or more reference pictures and the selected motion candidate.

The up-sampler or down-sampler inputting module 1024 may be configured to input the reconstructed frame into the up-sampler or down-sampler module 1010.

The ratio determining module 1026 may be configured to determine a ratio of the resolution of the current frame to the resolutions of the one or more reference pictures.

The scaling module 1030 may be configured to scale motion vectors of the one or more reference pictures in accordance with the ratio.

The inter predictor resizing module 1032 may be configured to resize inter predictors of the one or more reference pictures in accordance with the ratio.

The filter coefficient detecting and difference transmitting module 1034 may be configured to detect an up-sample or down-sample filter coefficient signaled in a sequence header or picture header of the current frame, and transmit a difference between the signaled filter coefficient and a filter coefficient of the current frame to the video decoder.

The up-sampled or down-sampled reconstructed frame generating module 1036 may be configured to generate an up-sampled or down-sampled reconstructed frame based on the reconstructed frame.

The buffer inputting module 1038 may be configured to input the up-sampled or down-sampled reconstructed frame into at least one of the reference frame buffer and a display buffer, as abovementioned with reference to FIG. 8.

The system 1000 may additionally include an input/output (I/O) interface 1040 for receiving bitstream data to be processed, and for outputting reconstructed frames into a reference frame buffer and/or a display buffer. The system 1000 may also include a communication module 1050 allowing the system 1000 to communicate with other devices (not shown) over a network (not shown). The network may include the Internet, wired media such as a wired network or direct-wired connections, and wireless media such as acoustic, radio frequency (RF), infrared, and other wireless media.

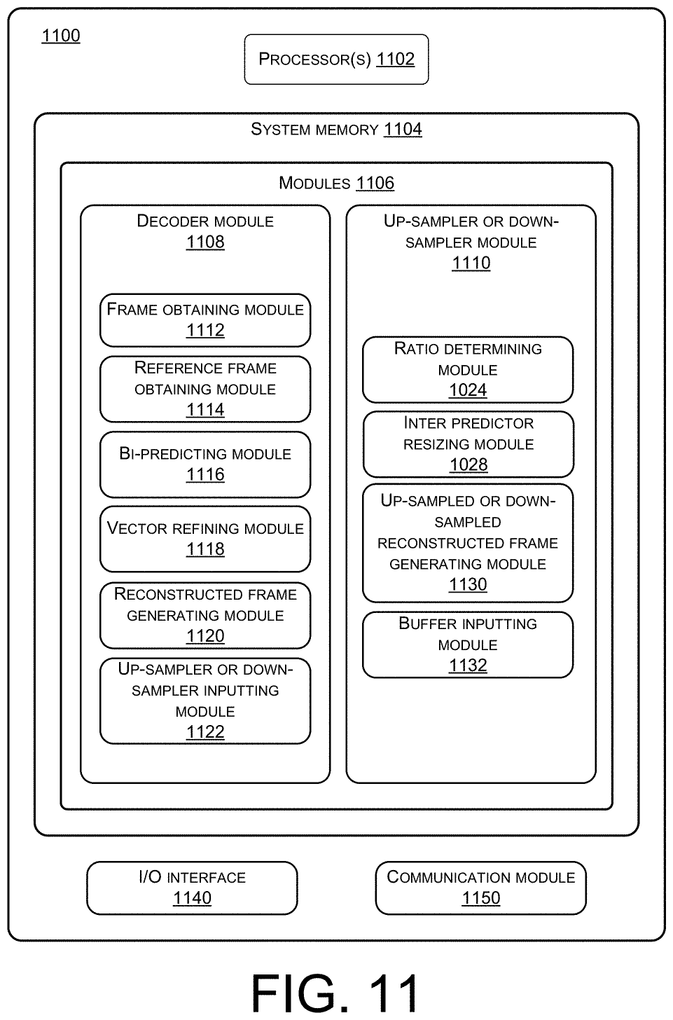

FIG. 11 illustrates an example system 1100 for implementing the processes and methods described above for implementing resolution-adaptive video coding in a motion prediction coding format.

The techniques and mechanisms described herein may be implemented by multiple instances of the system 1100 as well as by any other computing device, system, and/or environment. The system 1100 shown in FIG. 11 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1100 may include one or more processors 1102 and system memory 1104 communicatively coupled to the processor(s) 1102. The processor(s) 1102 may execute one or more modules and/or processes to cause the processor(s) 1102 to perform a variety of functions. In some embodiments, the processor(s) 1102 may include a central processing unit (CPU), a graphics processing unit (GPU), both CPU and GPU, or other processing units or components known in the art. Additionally, each of the processor(s) 1102 may possess its own local memory, which also may store program modules, program data, and/or one or more operating systems.

Depending on the exact configuration and type of the system 1100, the system memory 1104 may be volatile, such as RAM, non-volatile, such as ROM, flash memory, miniature hard drive, memory card, and the like, or some combination thereof. The system memory 1104 may include one or more computer-executable modules 1106 that are executable by the processor(s) 1102.

The modules 1106 may include, but are not limited to, a decoder module 1108 and an up-sampler or down-sampler module 1110. The decoder module 1108 may include a frame obtaining module 1112, a reference picture obtaining module 1114, a bi-predicting module 1116, a vector refining module 1118, an up-sampled or down-sampled reconstructed frame generating module 1120, and an up-sampler or down-sampler inputting module 1122. The up-sampler or down-sampler module 1110 may include a ratio determining module 1124, a pixel pattern resizing module 1128, an up-sampled or down-sampled reconstructed frame generating module 1130, and a buffer inputting module 1132.

The frame obtaining module 1112 may be configured to obtain a current frame of a bitstream encoded in the BIO coding format as abovementioned with reference to FIG. 9.

The reference picture obtaining module 1114 may be configured to obtain one or more reference pictures from a reference frame buffer and compare resolutions of the one or more reference pictures to a resolution of a current frame as abovementioned with reference to FIG. 9.

The bi-predicting module 1116 may be configured to perform bi-prediction upon the current frame based on a first reference frame and a second reference frame of the reference frame buffer, as abovementioned with reference to FIG. 9.

The vector refining module 1118 may be configured to perform vector refinement during the bi-prediction process based on a first reference frame and a second reference frame of the reference frame buffer, as abovementioned with reference to FIG. 6.

The reconstructed frame generating module 1120 may be configured to generate a reconstructed frame from the current frame based on the first reference frame and the second reference frame.

The up-sampler or down-sampler inputting module 1122 may be configured to input the reconstructed frame into the up-sampler or down-sampler module 1110.

The ratio determining module 1124 may be configured to determine a ratio of the resolution of the current frame to the resolutions of the one or more reference pictures.

The pixel pattern resizing module 1128 may be configured to resize pixel patterns of the one or more reference pictures in accordance with the ratio.

The up-sampled or down-sampled reconstructed frame generating module 1130 may be configured to generate an up-sampled or down-sampled reconstructed frame based on the reconstructed frame.

The buffer inputting module 1132 may be configured to input the up-sampled or down-sampled reconstructed frame into at least one of the reference frame buffer and a display buffer as abovementioned with reference to FIG. 9.

The system 1100 may additionally include an input/output (I/O) interface 1140 for receiving bitstream data to be processed, and for outputting reconstructed frames into a reference frame buffer and/or a display buffer. The system 1100 may also include a communication module 1150 allowing the system 1100 to communicate with other devices (not shown) over a network (not shown). The network may include the Internet, wired media such as a wired network or direct-wired connections, and wireless media such as acoustic, radio frequency (RF), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RANI), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-11. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides inter-coded resolution-adaptive video coding supported by motion prediction coding formats, improving the video coding process under multiple motion prediction coding formats by enabling resolution changes between frames to be coded while allowing motion vectors to reference previous frames. Thus, the bandwidth savings of inter-coding are maintained, the bandwidth savings of motion prediction coding are realized allowing reference frames to be used to predict motion vectors of subsequent frames, and the bandwidth savings of adaptively down-sampling and up-sampling according to bandwidth availability are also realized, all at the same time, achieving substantial improvement of network costs during video coding and content delivery while reducing the transport of additional data that would offset or compromise these savings.

### Example Clauses

A. A method comprising: obtaining a current frame of a bitstream; obtaining one or more reference pictures from a reference frame buffer having resolutions different from a resolution of the current frame; resizing an inter predictor of the one or more reference pictures; and generating a reconstructed frame from the current frame based on the one or more reference pictures and motion information of one or more blocks of the current frame, the motion information including at least one inter predictor.

B. The method as paragraph A recites, further comprising: comparing resolutions of the one or more reference pictures to a resolution of the current frame; upon determining that one or more resolutions of the one or more reference pictures are different from the resolution of the current frame, selecting a frame from the reference frame buffer having a same resolution as the resolution of the current frame; and determining a ratio of the resolution of the current frame to the resolutions of the one or more reference pictures; resizing the one or more reference pictures in accordance with the ratio to match the resolution of the current frame; up-sampling or down-sampling the inter predictor of the one or more reference pictures in accordance with the ratio; and scaling motion vectors of the one or more reference pictures in accordance with the ratio.

C. The method as paragraph A recites, further comprising: deriving an affine merge candidate list or an AMVP candidate list for the current frame; selecting a CPMVP candidate or an AMVP candidate from the affine merge candidate list or the AMVP candidate list, respectively; and deriving a motion vector of the motion candidate as a motion vector of the block of the reconstructed frame.

D. The method as paragraph C recites, further comprising: deriving at least one of an inherited affine merge candidate and a constructed affine merge candidate, and adding the at least one of an inherited affine merge candidate and a constructed affine merge candidate to the affine merge candidate list or the AMVP candidate list.

E. The method as paragraph A recites, further comprising: generating a reconstructed frame from the current frame based on the one or more reference pictures and at least one inter predictor; inputting the reconstructed frame into at least one of the in-loop up-sampler or down-sampler and a post-loop up-sampler or down-sampler; generating an up-sampled or down-sampled reconstructed frame based on the reconstructed frame; and inputting the up-sampled or down-sampled reconstructed frame into at least one of the reference frame buffer and a display buffer.

F. A method comprising: obtaining a current frame of a bitstream; obtaining one or more reference pictures from a reference frame buffer and comparing resolutions of the one or more reference pictures to a resolution of the current frame; and upon determining that one or more resolutions of the one or more reference pictures are different from the resolution of the current frame, resizing a pixel pattern of the one or more reference pictures in accordance with the resolution of the current frame.

G. The method as paragraph F recites, further comprising performing bi-prediction upon the current frame based on a first reference frame and a second reference frame of the reference frame buffer.

H. The method as paragraph G recites, wherein performing bi-prediction upon the current frame further comprises performing vector refinement upon the current frame based on a first reference frame and a second reference frame of the reference frame buffer.

I. The method as paragraph H recites, further comprising generating a reconstructed frame from the current frame based on the first reference frame and the second reference frame; inputting the reconstructed frame into at least one of the in-loop up-sampler or down-sampler and a post-loop up-sampler or down-sampler; generating an up-sampled or down-sampled reconstructed frame based on the reconstructed frame; and inputting the up-sampled or down-sampled reconstructed frame into at least one of the reference frame buffer and a display buffer.

J. A method comprising: obtaining a current frame of a bitstream, the bitstream including frames having a plurality of resolutions; obtaining from a reference frame buffer one or more reference pictures; generating a reconstructed frame from the current frame based on the one or more reference pictures and motion information of one or more blocks of the current frame, the motion information including at least one inter predictor; and up-sampling or down-sampling the current reconstructed frame for each resolution of the plurality of resolutions to generate an up-sampled or down-sampled reconstructed frame matching the respective resolution.

K. The method as paragraph J recites, further comprising detecting an up-sample or down-sample filter coefficient signaled for at least one of the one or more reference pictures.

L. The method as paragraph K recites, further comprising applying a difference between a filter coefficient of the inter predictor and a filter coefficient of the current frame to coding a filter of the current frame.

M. The method as paragraph J recites, further comprising inputting the reconstructed frame and each up-sampled or down-sampled reconstructed frame into the reference frame buffer.

N. A system comprising: one or more processors and memory communicatively coupled to the one or more processors, the memory storing computer-executable modules executable by the one or more processors that, when executed by the one or more processors, perform associated operations, the computer-executable modules including: a frame obtaining module configured to obtain a current frame of a bitstream; and a reference picture obtaining module configured to obtain one or more reference pictures from a reference frame buffer and compare resolutions of the one or more reference pictures to a resolution of a current frame.

O. The system as paragraph N recites, further comprising: a frame selecting module configured to select a frame from the reference frame buffer having a same resolution as the resolution of the current frame, upon the reference picture obtaining module determining that one or more resolutions of the one or more reference pictures are different from the resolution of the current frame.

P. The system as paragraph O recites, further comprising: a candidate list deriving module configured to derive an affine merge candidate list or an AMVP candidate list for a block of the current frame.

Q. The system as paragraph P recites, further comprising a motion predicting module configured to select a CPMVP or AMVP candidate from the derived affine merge candidate list or AMVP candidate list, respectively.

R. The system as paragraph Q recites, wherein the motion predicting module is further configured to derive a motion vector of the CPMVP or AMVP candidate as a motion vector of the block of the reconstructed frame.

S. The system as paragraph N recites, further comprising: a reconstructed frame generating module configured to generate a reconstructed frame from the current frame based on the one or more reference pictures and the selected motion candidate; an up-sampler or down-sampler inputting module configured to input the reconstructed frame into the up-sampler or down-sampler module; a ratio determining module configured to determine a ratio of the resolution of the current frame to the resolutions of the one or more reference pictures; an inter predictor resizing module configured to resize inter predictors of the one or more reference pictures in accordance with the ratio; a filter coefficient detecting and difference transmitting module configured to detect an up-sample or down-sample filter coefficient signaled in a sequence header or picture header of the current frame, and transmit a difference between the signaled filter coefficient and a filter coefficient of the current frame to the video decoder; a scaling module configured to scale motion vectors of the one or more reference pictures in accordance with the ratio; an up-sampled or down-sampled reconstructed frame generating module configured to generate an up-sampled or down-sampled reconstructed frame based on the reconstructed frame; and a buffer inputting module configured to input the up-sampled or down-sampled reconstructed frame into at least one of the reference frame buffer and a display buffer.

T. A system comprising: one or more processors and memory communicatively coupled to the one or more processors, the memory storing computer-executable modules executable by the one or more processors that, when executed by the one or more processors, perform associated operations, the computer-executable modules including: a frame obtaining module configured to obtain a current frame of a bitstream; and a reference picture obtaining module configured to obtain one or more reference pictures from a reference frame buffer and compare resolutions of the one or more reference pictures to a resolution of a current frame.

U. The system as paragraph T recites, further comprising: a bi-predicting module configured to performs bi-prediction upon the current frame based on a first reference frame and a second reference frame of the reference frame buffer.

V. The system as paragraph U recites, further comprising: a vector refinement module configured to perform vector refinement during the bi-predicting process based on a first reference frame and a second reference frame of the reference frame buffer.

W. The system as paragraph V recites, further comprising: a reconstructed frame generating module configured to generate a reconstructed frame from the current frame based on the first reference frame and the second reference frame; an up-sampler or down-sampler inputting module configured to input the reconstructed frame into the up-sampler or down-sampler module; an up-sampled or down-sampled reconstructed frame generating module configured to generate an up-sampled or down-sampled reconstructed frame based on the reconstructed frame; and a buffer inputting module configured to input the up-sampled or down-sampled reconstructed frame into at least one of the reference frame buffer and a display buffer.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
obtaining a current frame of a bitstream;
obtaining one or more reference pictures from a reference frame buffer, the one or more reference pictures having resolutions different from a resolution of the current frame;
resizing one or more inter predictors and/or scaling one or more motion vectors obtained from the one or more reference pictures; and
generating a reconstructed frame from the current frame based on motion information of one or more blocks of the current frame, the motion information comprising at least one inter predictor and/or at least one motion vector.

2. The method of claim 1, wherein resizing the one or more inter predictors is performed in accordance with a ratio of the resolution of the current frame and the resolution of the one or more reference pictures, to match the resolution of the current frame; and further comprising:
inputting the reconstructed frame into the reference frame buffer as a reference picture.

3. The method of claim 1, wherein scaling the one or more motion vectors is performed in accordance with a ratio of the resolution of the current frame and the resolution of the one or more reference pictures, to match the resolution of the current frame; and further comprising:
inputting the reconstructed frame into the reference frame buffer as a reference picture.

4. The method of claim 1, further comprising deriving an affine merge candidate list or an AMVP candidate list for a block of the current frame, the affine merge candidate list or the AMVP candidate list comprising a plurality of CPMVP candidates or AMVP candidates, respectively.

5. The method of claim 4, wherein deriving the affine merge candidate list or the AMVP candidate list comprises deriving up to two inherited affine merge candidates.

6. The method of claim 4, wherein deriving the motion candidate list comprises deriving a constructed affine merge candidate.

7. The method of claim 4, further comprising:
selecting a CPMVP candidate or AMVP candidate from the derived affine merge candidate list or AMVP candidate list, respectively; and
deriving motion information of the CPMVP candidate or the AMVP candidate as motion information of the block of the current frame.

8. The method of claim 8, wherein the motion candidate comprises a reference to a reference picture, and deriving motion information of the motion candidate further comprises:
generating a plurality of CPMVs based on the reference to motion information of a reference picture.

9. A computer-readable storage medium storing computer-readable instructions executable by one or more processors, that when executed by the one or more processors, cause the one or more processors to perform operations comprising:
obtaining a current frame of a bitstream;
obtaining one or more reference pictures from a reference frame buffer;
detecting an up-sample or down-sample filter coefficient signaled for at least one of the one or more reference pictures;
generating a reconstructed frame from the current frame based on the one or more reference pictures and motion information of one or more blocks of the current frame, the motion information comprising at least one reference to motion information of another frame; and
up-sampling or down-sampling the current reconstructed frame in accordance with a resolution to generate an up-sampled or down-sampled reconstructed frame matching the resolution.

10. The computer-readable storage medium of claim 9, wherein the operations further comprise receiving a difference between a filter coefficient of the inter predictor and a filter coefficient of the current frame.

11. The computer-readable storage medium of claim 10, wherein the operations further comprise applying the difference between the filter coefficient of the inter predictor and the filter coefficient of the current frame to coding a filter of the current frame.

12. The computer-readable storage medium of claim 9, wherein the operations further comprise inputting the reconstructed frame and the up-sampled or down-sampled reconstructed frame into the reference frame buffer as a reference picture.

13. A system comprising:
one or more processors; and
memory communicatively coupled to the one or more processors, the memory storing computer-executable modules executable by the one or more processors that, when executed by the one or more processors, perform associated operations, the computer-executable modules comprising:
a frame obtaining module configured to obtain a current frame of a bitstream;
a reference frame obtaining module configured to obtain one or more reference pictures from a reference frame buffer, the one or more reference pictures having resolutions different from a resolution of the current frame;
an inter predictor resizing module configured to resize one or more inter predictors of the one or more reference pictures;
a scaling module configured to scale one or more motion vectors of the one or more reference pictures; and
a reconstructed frame generating module configured to generate a reconstructed frame from the current frame based on motion information of one or more blocks of the current frame, the motion information comprising at least one inter predictor and/or at least one motion vector.

14. The system of claim 13, wherein the inter predictor resizing module is further configured to resize the one or more inter predictors based on the resolution of the current frame in accordance with a ratio of the resolution of the current frame and the resolution of the one or more reference pictures, to match the resolution of the current frame; and
further comprising:
a buffer inputting module configured to input the reconstructed frame into the reference frame buffer as a reference picture.

15. The system of claim 13, wherein the scaling module is further configured to scale the one or more motion vectors based on the resolution of the current frame in accordance with a ratio of the resolution of the current frame and the resolution of the one or more reference pictures, to match the resolution of the current frame; and
further comprising:
a buffer inputting module configured to input the reconstructed frame into the reference frame buffer as a reference picture.

16. The system of claim 13, further comprising a candidate list deriving module configured to derive an affine merge candidate list or an AMVP candidate list for a block of the current frame, the affine merge candidate list or the AMVP candidates list comprising a plurality of CPMVP candidates or AMVP candidates, respectively.

17. The system of claim 16, wherein deriving the affine merge candidate list or the AMVP candidate list comprises deriving up to two inherited affine merge candidates.

18. The system of claim 16, wherein deriving the motion candidate list comprises deriving a constructed affine merge candidate.

19. The system of claim 16, further comprising a motion predicting module configured to select a CPMVP candidate or AMVP candidate from the derived affine merge candidate list or AMVP candidate list, respectively, and to derive motion information of the CPMVP candidate or the AMVP candidate as motion information of the block of the current frame.

20. The system of claim 19, wherein the motion candidate comprises a reference to motion information of a reference picture, and the motion predicting module is further configured to:
generate a plurality of CPMVs based on the reference to motion information of a reference picture.
